(19) United States
(12) Patent Application Publication
(10) Pub. No.: US 2004/0053634 A1
(43) Pub. Date: Mar. 18, 2004

(54) Adaptive pointing for use with directional antennas operating in wireless networks

(75) Inventors: Kenneth M. Gainey, Satellite Beach, FL (US); James C. Otto, Melbourne, FL (US); Jonathan L. Hughes, Melbourne, FL (US); Griffin K. Gothard, Satellite Beach, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tantivy Communications, Inc., Melbourne, FL (US)

(21) Appl. No.: 10/429,183

(22) Filed: May 2, 2003

Related U.S. Application Data
(60) Provisional application No. 60/377,458, filed on May 2, 2002.
(60) Provisional application No. 60/378,156, filed on May 14, 2002.
(60) Provisional application No. 60/378,157, filed on May 14, 2002.
(60) Provisional application No. 60/377,911, filed on May 3, 2002.

(51) Int. Cl. H04B 7/00

(52) U.S. Cl. 455/522

(57) ABSTRACT

A directional antenna is pointed based on a ranking process. The ranking process of choice uses both Eₛ/Nₒ and Pilot Power parameters as measured from a pilot signal for best overall system performance in the forward and reverse links. Using this pointing and ranking process enables adaptive pointing of the directional antenna in interference and multi-path driven environments. The pointing and ranking process may be used to select the “best” pointing angle for communicating with a given base station or for selecting the given base station. The process may include fine tuning techniques for use in different environments. The fine tuning may include the use of weights related to the operating environment or directivity of the directional antenna.

### RELATED APPLICATION(S)

This application claims the benefit of U.S. Provisional Application No. 60/377,458, filed on May 2, 2002, U.S. Provisional Application No. 60/378,156, filed on May 14, 2002, U.S. Provisional Application No. 60/378,157, filed on May 14, 2002, and U.S. Provisional Application No. 60/377,911, filed on May 3, 2002. The entire teachings of the above applications are incorporated herein by reference.

### BACKGROUND OF THE INVENTION

Code Division Multiple Access (CDMA) modulation may be used to provide wireless communication between a base station and one or more field units. In CDMA cellular systems, multiple field units may transmit and receive signals on the same frequency but with different codes to permit detection of signals on a per unit basis. A typical field unit is a digital cellular telephone handset or a personal computer coupled to a cellular modem.

The base station is typically a computer controlled set of transceivers that are interconnected to a land-based public switched telephone network (PSTN) or in the case of a data system, an Internet gateway such as through an Internet Service Provider (ISP). The base station includes an antenna apparatus for sending forward link radio frequency signals to the field units. The base station antenna is also responsible for receiving reverse link radio frequency signals transmitted from each field unit. Each field unit also contains an antenna apparatus for the reception of the forward link signals and for transmission of the reverse links signals.

The most common type of antenna used to transmit and receive signals at a field unit is a mono-pole or omni-directional antenna. This type of antenna consists of a single wire or antenna element that is coupled to a transceiver within the field unit. The transceiver receives reverse link signals to be transmitted from circuitry within the field unit and modulates the signals onto the antenna element at a specific frequency assigned to that field unit. Forward link signals received by the antenna element at a specific frequency are demodulated by the transceiver and supplied to processing circuitry within the field unit.

The signal transmitted from a monopole antenna is omnidirectional in nature. That is, the signal is sent with the same signal strength in all directions in a generally horizontal plane. Reception of a signal with a monopole antenna element is likewise omni-directional. A monopole antenna does not differentiate in its ability to detect a signal in one direction versus detection of the same or a different signal coming from another direction.

A second type of antenna which may be used by field units is described in U.S. Pat. No. 5,617,102. The system described therein provides a directional antenna comprising two antenna elements mounted on the outer case of a laptop computer. The system includes a phase shifter attached to the two elements. The phase shifter may be switched on or off in order to affect the phase of signals transmitted or received during communications to and from the computer. By switching the phase shifter on, the antenna transmit pattern may be adapted to a predetermined hemispherical pattern which provides transmit beam pattern areas having a concentrated signal strength or gain. The dual element antenna directs the signal into predetermined quadrants or hemispheres to allow for large changes in orientation relative to the base station while minimizing signal loss.

CDMA cellular systems are also recognized as being interference limited systems. That is, as more field units become active in a cell and in adjacent cells, frequency interference becomes greater and thus error rates increase. As error rates increase, maximum data rates decrease. Thus, another method by which data rate can be increased in a CDMA system is to decrease the number of active field units, thus clearing the airwaves of potential interference. For instance, to increase a current maximum available data rate by a factor of two, the number of active field units can be decreased by one half. However, this is rarely an effective mechanism to increase data rates due to a lack of priority amongst users.

### SUMMARY OF THE INVENTION

Both simulation and field measurements have shown that operations of directional antennas in frequency duplexed systems operating in interference/multi-path environments can be contradictory. In other words, since transmit and receive frequencies are different and because interference can come from any direction, the optimum settings for a directional antenna may not be the same for a forward link as for a reverse link. Consideration should be given to optimizing the forward link operation, while still achieving a suitable reverse link. Because of this, some sort of process is needed to determine the best antenna settings when attempting to set-up the reverse link.

To optimize reception of the forward link signal, the antenna apparatus can be pointed via phase or mechanical steering techniques at the angle which gives the largest signal-to-noise ratio (Eₛ/Nₒ), where Eₛ is defined as energy per symbol and Nₒ is defined as total noise in dB. This is because Eₛ/Nₒ is the main metric that defines overall system performance. If a better Eₛ/Nₒ ratio is achieved, the amount of power supplied to a user to support the same data throughput can be reduced. But, in many cases, pointing based on only Eₛ/Nₒ can result in a significant degradation in reverse link performance. This is because pointing based on Eₛ/Nₒ may steer the antenna beam at an angle away from the base station with which the field unit is communicating to reduce interference from a base station in an adjacent cell. Thus, when using an antenna apparatus associated with most low-cost portable antenna arrays that do not allow for separate and independent pointing beams for transmit and receive, the communications in the forward link will be optimized, but the communications in the reverse link may not be optimized for the same antenna direction selection. To maximize overall communications performance in both forward and reverse directions, direction selection should also be based on a metric associated with optimized performance in the reverse link, such as pilot power.

Accordingly, the present invention provides a technique that can be used to point a directional antenna based on a ranking process. The ranking process of choice may use both Eₛ/Nₒ and Pilot Power parameters as measured from a pilot signal. Using this pointing and ranking process enables adaptive pointing of directional antennas in interference and multi-path driven environments where there is only one antenna beam to point for both transmit and receive links. This is especially useful for an application where transmit and receive links are separated (i.e., duplexed) in frequency.

In addition to selecting antenna angle settings based on metrics associated with good forward and reverse link performance, the system may use this process for initial base station acquisition or start it after establishing a link with a base station, for example, in omni-directional mode. In addition, weights may be combined with the metrics to account for various environments or directional factors.

Various phenomena directly affect the performance of antenna pointing processes. These phenomena may be different from one environment to another and may include severity of multi-path, amount of interference, and Root-Mean-Square (RMS) delay spread.

In one embodiment, the angle settings may be fine tuned for use with directional antenna pointing systems that operate in different environments. The fine tuning applies adjustment factors or weights to the metrics used in determining the angle settings to maximize the performance of the directional antenna in any environment.

In addition to the environmental weights, a system employing the principles of the present invention may include weights associated with the antenna pattern. An example of such weights is an Antenna Pattern Correlation Factor (CF), which can be used independent of or in conjunction with other processes to improve directional antenna pointing. The CF is the result of a comparison of patterns that can be, but are not limited to, expressions in discrete or continuous form. The comparison can be performed by discrete or continuous convolution or by some other comparison technique such as, but not limited to, least mean square. The use of CF allows for selection of the “best” pointing direction even when the metric varies significantly at different pointing angles.

The independent use of the CF allows for finding the center of mass of the “best” received pilot power signal, signal-to-noise ratio, frame error rate, delay spread, and other receiver signal metrics. Using the CF in conjunction with another weighting process allows for weighting of various metrics within the process, such as weighting based on multi-path severity.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a system which employs two different types of channel encoding;

FIG. 2 illustrates a cell of a CDMA cellular communications system using a directional antenna apparatus;

FIG. 3 illustrates a preferred configuration of the directional antenna apparatus used by a field unit in the cellular communications system of FIG. 2;

FIG. 4 illustrates an alternative configuration of the directional antenna apparatus used by the field unit in FIG. 3;

FIG. 5 is a system diagram of the communications system of FIG. 2 depicting the field unit with directional antenna patterns;

FIG. 6 is a circuit diagram used by the field unit to determine metrics used to select one of the antenna angles of FIG. 5;

FIG. 7 is a generalized flow diagram of a process used by the field unit for selecting the angle setting based on the metrics of FIG. 6;

FIG. 8 is a flow diagram used by the process of FIG. 7 for selecting and ranking the angle settings;

FIG. 9A is a detailed flow diagram of a first aspect of the process of FIG. 7;

FIG. 9B is a detailed flow diagram of a second aspect of the process of FIG. 7;

FIG. 10 is a flow diagram of a process used to calculate weights for optional use by the process of FIG. 7;

FIG. 11 is a theoretical free space directional antenna pattern replicated ten times using ten different reference positions for use by the process of FIG. 10;

FIG. 12 is a theoretical free space directional antenna pattern and a superimposed theoretically measured pilot power pattern for use by the process of FIG. 10; and

FIG. 13 is a plot of an actual measured free space antenna pattern and a measured pilot power pattern annotated with arrows for which calculations may be made for calculating a maximum Correlation Factor (CF) applied as a weight in FIG. 10.

### DETAILED DESCRIPTION OF THE INVENTION

A description of preferred embodiments of the invention follows.

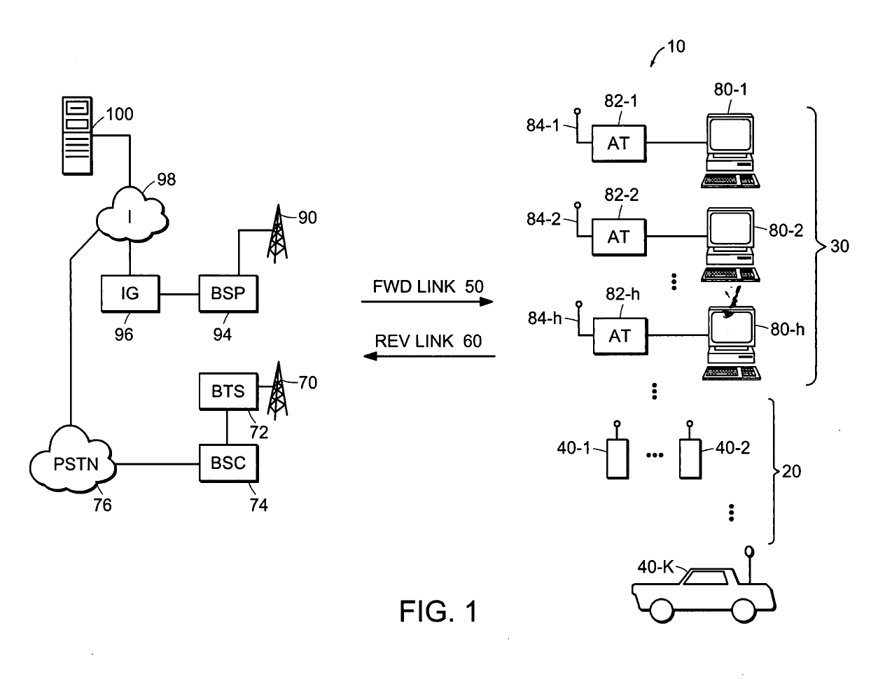

FIG. 1 is a block diagram of a Code Division Multiple Access (CDMA) communications system 10. The communications system 10 is described such that the shared channel resource is a wireless or radio channel. Although depicted as a cellular communications network, it should be understood that the techniques described herein can be applied to other wireless networks, such as Wireless Local Area Networks (WLAN's).

The system 10 supports wireless communications for a first group of users 20 as well as a second group of users 30. The first group of users 20 are typically legacy users of cellular telephone equipment, such as wireless handsets 40-1, 40-2, and/or cellular mobile telephones 40-k installed in vehicles. This first group of users 20 principally use the network in a voice mode whereby their communications are encoded as continuous transmissions. The users' transmissions are forwarded from the subscriber units 40 through forward link 50 radio channels and reverse link 60 radio channels. Their signals are managed at a central location that includes a base station antenna 70, base transceiver station (BTS) 72, and base station controller (BSC) 74. The first group of users 20 are therefore typically engaged in voice conversations using the field units 40, BTS 72, and BSC 74 to connect telephone connections through a Public Switch Telephone Network (PSTN) 76.

The communications system 10 also includes a second group of users 30. This second group of users 30 are typically users who require high speed wireless data services. Their system components include a number of remotely located Personal Computer (PC) devices 80-1, 80-2, . . . 80-h, . . . 80-1, corresponding remote Access Terminals (ATs) 82-1, 82-2, . . . 82-h, . . . 82-1, and associated antennas 84-1, 84-2, . . . 84-h, . . . 84-1. Centrally located equipment includes a base station antenna 90 and a Base Station Processor (BSP) 92. The BSP 92 provides connections to and from an Internet gateway 96, which in turn provides access to a data network such as the Internet 98, and network file server 100.

The operation of a system that allows for multi-user orthogonal and non-orthogonal interoperability of code channels that supports the two groups of users is described in International Publication Number WO 02/09320, the entire teachings of which are incorporated herein by reference.

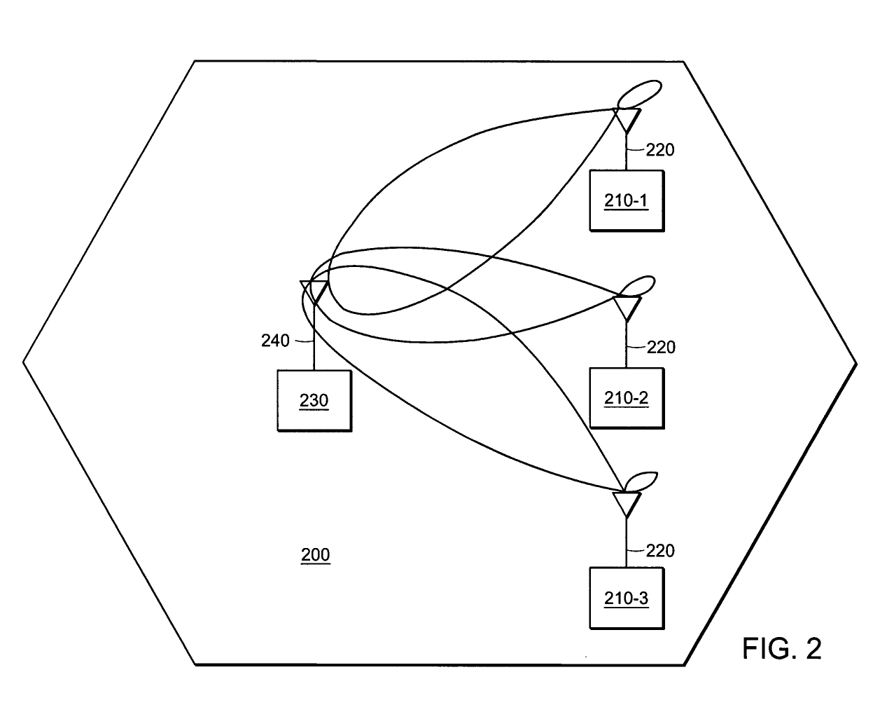

FIG. 2 illustrates a cell of a CDMA cellular communications system using a directional antenna apparatus. The field units 210-1 through 210-3 with respective antennas 220 provide directional reception of forward link radio signals transmitted from base station 230 with antenna 240, as well as providing directional transmission of reverse link signals, via a process called beamforming, from the field units 210 to the base station 230. Beamforming may be performed by directional antenna arrays that include active antenna elements or combination of active and passive antenna elements.

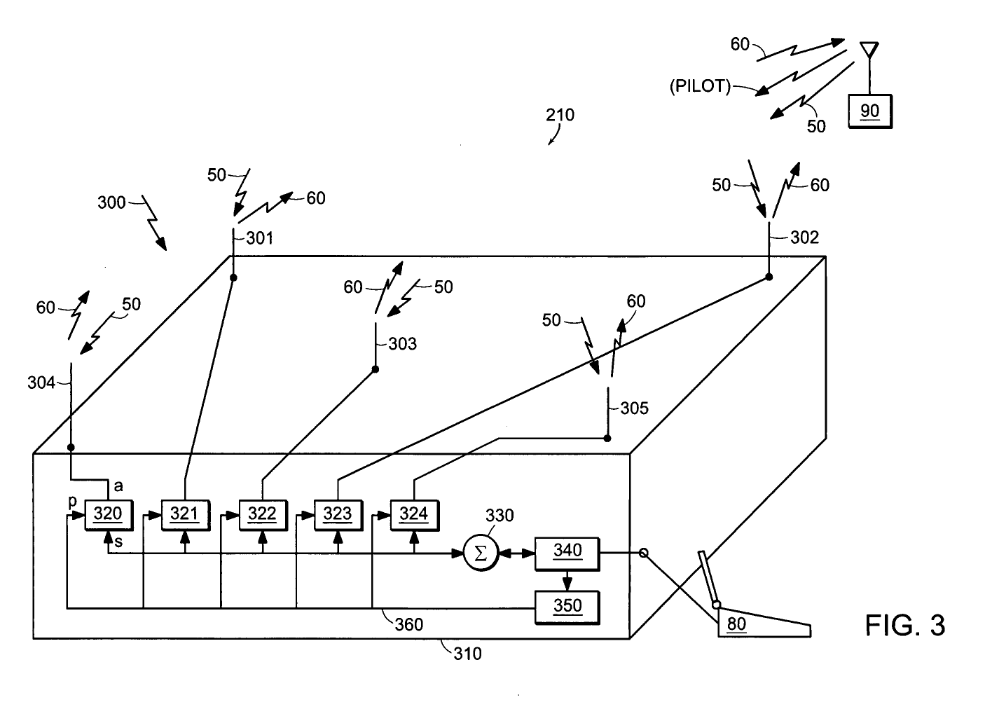

FIG. 3 illustrates a detailed isometric view of a mobile subscriber unit 210 and one type of associated antenna apparatus 300. The antenna apparatus 300 includes a platform or housing 310 upon which five antenna elements 301 through 305 are mounted. Within the housing 310, the antenna apparatus 300 includes phase shifters 320 through 324, a bi-directional summation network or splitter/combiner 330, transceiver 340, and control processor 350, which are all interconnected via a bus 360.

As illustrated, the antenna apparatus 300 is coupled via the transceiver 340 to a laptop computer 80 (not drawn to scale). This phase array type antenna apparatus 300 allows the laptop computer 80 to perform wireless data communications via forward link signals 50 transmitted from a base station 90 and reverse link signals 60 transmitted to the base station 90.

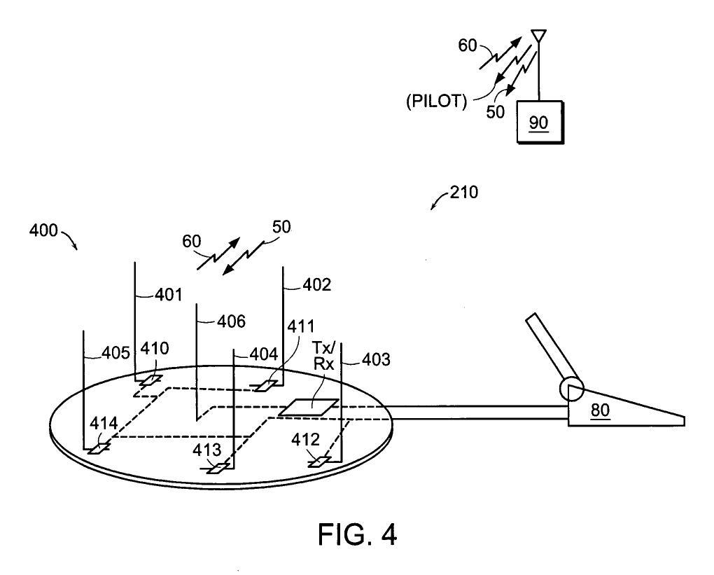

FIG. 4 illustrates a detailed isometric view of a field unit 210 and another antenna apparatus 400. This antenna apparatus 400 is an alternative embodiment of the previously discussed antenna apparatus 300 (FIG. 3). In contrast to the earlier presented antenna apparatus 300, this antenna apparatus 400 employs multiple passive antenna elements 401 through 405 that are electromagnetically coupled (i.e., mutually coupled) to a centrally located active antenna element 406. The passive antenna elements 401 through 405 re-radiate electromagnetic energy, which affects the direction from/to which the active antenna element 406 receives/transmits RF signals, respectively. The direction of the antenna pattern (not shown) is affected by the phase of the individual passive antenna elements 401-405, which are set by selectable impedance components 410-414, respectively. The laptop computer 80 or specialized processor (not shown) in the laptop computer 80, antenna apparatus 400, or separate device may be used to determine the setting for each of the selectable impedance components 410-414 to control the angle setting of the antenna pattern produced by the antenna apparatus 400.

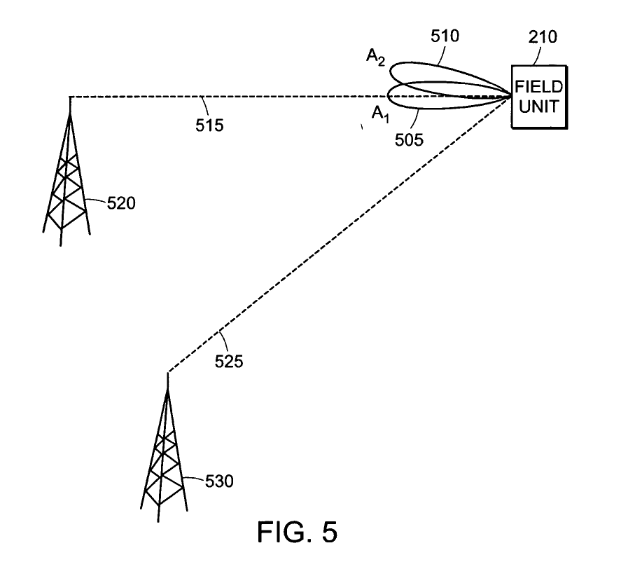

FIG. 5 is a network diagram of the field unit 210 communicating with base stations (not shown) associated with base station antenna towers 520 and 530. The field unit 210 has a directional antenna 400 (FIG. 4) that is capable of providing an antenna pattern at a first antenna beam angle 505 and second antenna beam angle 510. It should be understood that the directional antenna 400 is capable of providing many more beam angles; the first and second antenna beam angles 505, 510, respectively, are shown for exemplary purposes.

The field unit 210 may start a scan with the antenna beam pointed in the first antenna beam angle 505 directly at the first antenna tower 520. Forward link signals are sent from the first antenna tower 520 to the field unit 210 along a first transmission path 515. At the same time, the second antenna tower 530 si sending forward link signals to the field unit 210 along a second transmission path 525. While receiving signals along the first transmission path 515 from the first antenna tower 520, the field unit 210 receives the forward link signals from the second antenna tower 530, which may be considered interference or noise, since the first antenna beam 505 has some gain in the direction of the second transmission path 525.

To reduce the interference from the second antenna tower 530, the field unit 210 scans the antenna beam from the first antenna beam angle 505 to the second antenna beam angle 510. In this way, the transmissions from the second antenna tower 530 along the second transmission path 525 are reduced since there is little to no gain in the antenna beam pattern at the second antenna beam angle 510 in the direction of the second transmission path 525. This results in a loss of some gain for receiving signals from the first antenna tower 520 (e.g., 5 dB loss) and, understandably, loss in reverse link signal gain from the field unit 210 to the first antenna tower 520.

However, it should be appreciated that overall, the communications between the field unit 210 and the first antenna tower 520 may be improved due to the reduction of interference from the signals received from the second antenna tower 530. Thus, by using metrics, such as Eₛ/Nₒ and pilot power, respectively associated with good performance in both the forward and reverse links, an overall improvement in communications performance may be achieved in the face of interference and multipath. In other words, selecting an angle setting suboptimal in one link direction may improve performance in the other link direction for improved overall performance of the field unit 210.

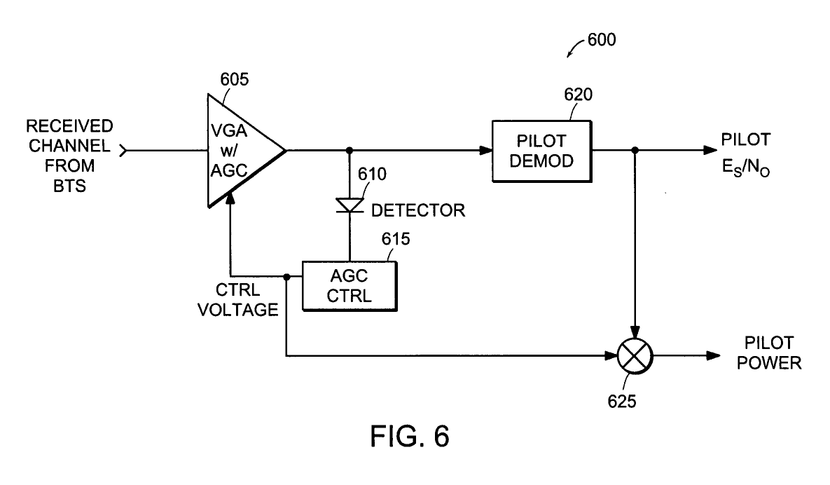

FIG. 6 provides an example processor 600, or part thereof, for determining metrics associated with the forward and reverse links. In this case, the processor 600 outputs (i) a first metric, calculated as a function of noise, such as the Pilot Eₛ/Nₒ, and (ii) a second metric, such as Pilot Power (PilotPwr).

Referring to the processor 600, a received channel from the base transceiver station (BTS) is received by a variable gain amplifier (VGA) 605. The output of the VGA 605 is received by a detector 610, which provides a signal to an automatic gain control (AGC) controller 615. The AGC controller 615 outputs a control voltage as feedback to the VGA 605.

The output of the VGA 605 is also received by a pilot demodulator 620. The pilot demodulator outputs a signal Eₛ/Nₒ, which may be representative of the energy per symbol divided by the total noise in the pilot channel. This signal is multiplied by the control voltage through use of a multiplier 625. Since the control voltage represents energy of the received channel, the resultant signal is the Pilot Power.

It should be understood that there is additional circuitry, not shown, that is used to isolate the Pilot channel from among the orthogonal channels sent in the forward link from the BTS to the field unit 210 in which this processor 600 is deployed.

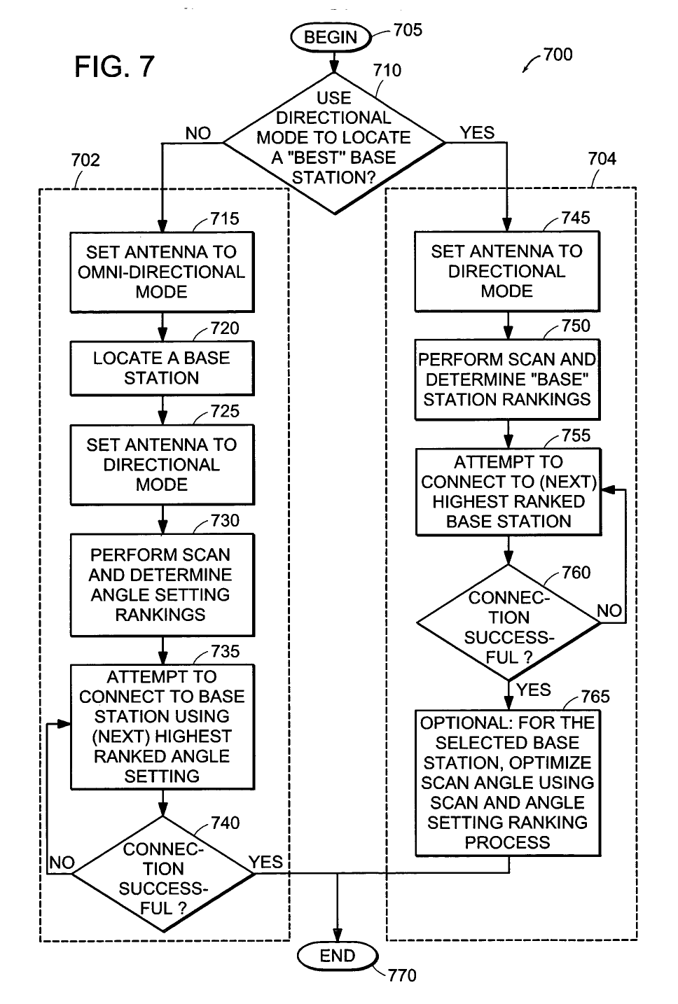

FIG. 7 is a flow diagram of a process 700 that illustrates alternative uses or timings in which the identification and selection of angle settings may be applied. This process 700 describes a “best angle selection” subprocess 702 and a “best base station selection” subprocess 704. In the best angle selection subprocess 702, the process 700 is already associated with a base station, and the process 700 identifies a best angle setting for the directional antenna to communicate with that base station, balanced for good performance in both forward and reverse links, as described above. In the best base station selection subprocess 704, the process 700 uses the scanning capability of the antenna to assist in searching for a “best” base station with which to communicate.

Referring to the process 700, after the process 700 has started (step 705), a determination is made as to whether to use directional mode of the antenna to locate a “best” base station (step 710) or to select a base station in omni-directional mode as is traditionally done. If the traditional method of locating a base station is selected, such as through identification of the pilot signal with the best signal-to-noise ratio (SNR), the process 700 sets its directional antenna to omni-directional mode (step 715) and locates a base station 720 based on measurements of a Pilot signal(s) that it receives from one or more base stations (step 720). Once a base station has been selected in omni-directional mode, the field unit 210 sets the directional antenna to a directional mode (step 725) and performs a scan to determine angle setting rankings of each of the angle settings associated with the directional antenna (step 730). As discussed above, determining the angle setting rankings is done as a function of a metric associated with the forward link and a metric associated with a reverse link between the base station and field unit 210.

Using the angle setting rankings, the field unit 210 may attempt to connect in the reverse link to the base station using the highest ranked angle setting (step 735). If the connection is successful (step 740), then the process is complete (step 770). If the connection is not successful (step 740), then the field unit 210 uses the directional antenna and attempts to connect to the base station using the next highest ranked angle setting (step 735). This process of attempting to use the next highest ranked angle setting (step 735) continues until a connection with the base station located in omni-directional mode 715 by the field unit has been successful or results in the field unit connecting to the base station in omni-directional mode, a step which is not shown but is used as a default should directional mode connection fail.

If the field unit 210 uses directional mode to locate a “best” base station (step 710) using the other subprocess 704, the process 700 sets the directional antenna 400 to directional mode (step 745). The process 700 performs a scan using the directional antenna and determines base station rankings through use of the angles in the scan (step 750). The base station rankings may be assigned as a function of the signal-to-noise (SNR) of the respective pilot signals of the base stations, as identified at each of the scan angles.

Once the scan is complete, the field unit 210, using the subprocess 704, attempts to connect to the highest ranked base station (step 755). If the connection is successful (step 760), the process 700 continues by either ending (step 770) or performing an optional step of optimizing the scan angle for the selected base station by using the scan and angle setting ranking process (765), similar to steps 735 and 740 of the other subprocess 702 described above. If the connection is not successful (step 760), the field unit 210 uses the directional antenna in an attempt to connect to the next highest ranked base station (step 755). Again, it should be understood that when attempting to connect to the next highest ranked base station, the directional antenna 400 is set to have a scan angle associated with that next highest ranked base station.

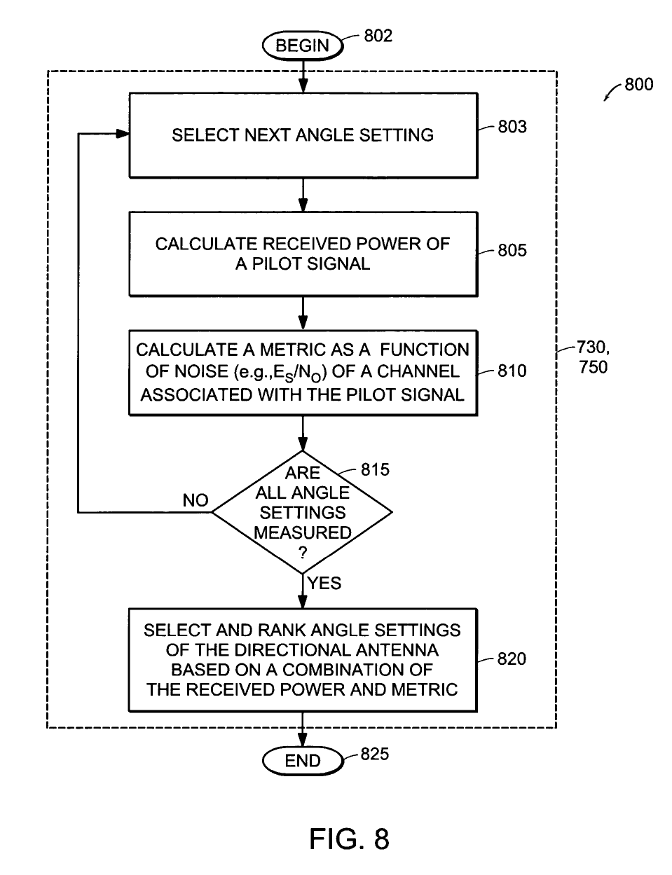

FIG. 8 is a flow diagram of a process 800 that performs a scan (steps 730 and 750) through use of the directional antenna 400, as described in reference to FIG. 7. After the process 800 begins (step 802), the process 800 selects a next angle setting (step 803) and calculates a received power of a pilot signal or other predetermined signal associated with a given base station (step 805). The process 800 calculates a metric as a function of noise (e.g., Eₛ/Nₒ) of a channel associated with the pilot signal (step 810). These three steps (803, 805, and 810) are repeated until all angle settings have been measured (step 815).

Following the measurements, the process 800 selects and ranks angle settings of the directional antenna based on a combination of the received power and metric (step 820). The process 800 is then complete (step 825), and a table, database, or other reference to the rankings and angle settings may be output from the process 800.

It should also be understood that this process may result in a single angle setting (i.e., the “best” angle setting) for use by the process 700 of FIG. 7, where the process 800, in this alternative embodiment, is used on an as-needed basis.

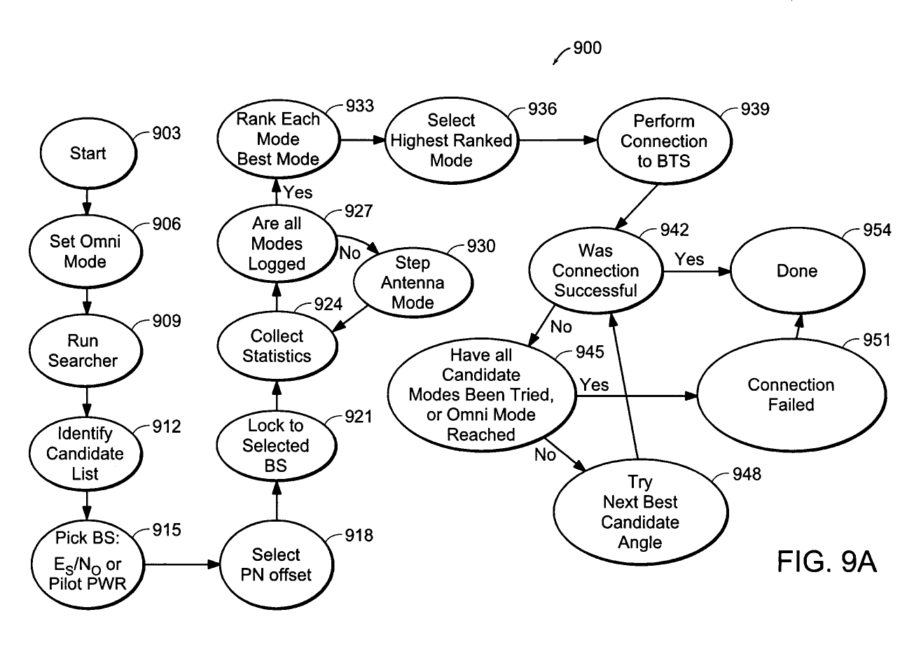

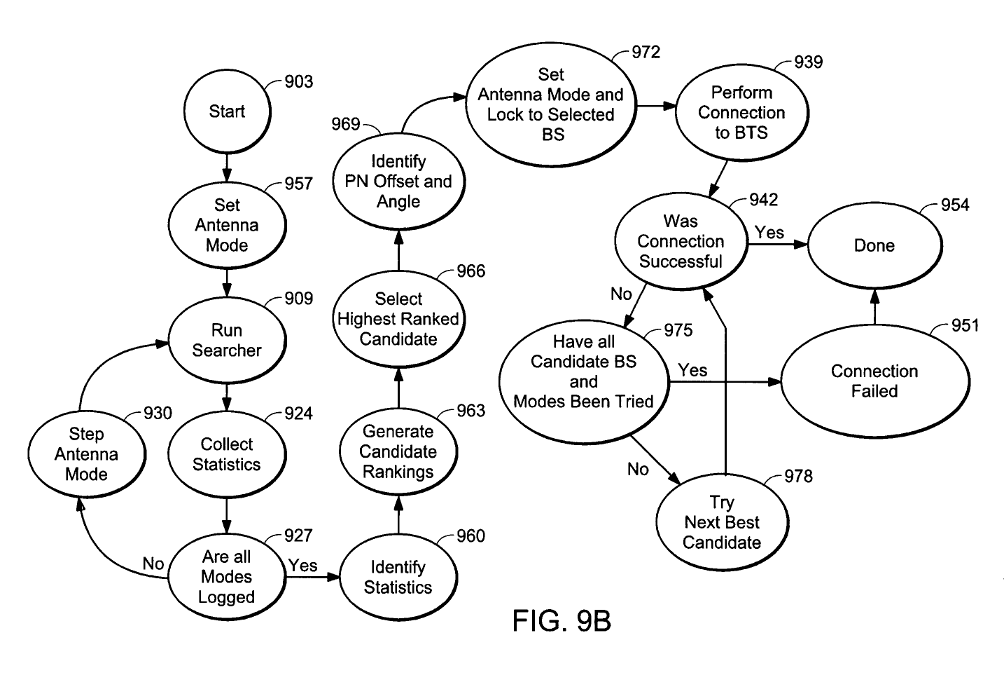

FIG. 9A is a flow diagram of a pointing process used to set the direction of the antenna apparatus 400 based on a ranking process. The controller 350 uses the pointing process to determine optimum impedance settings of the selectable impedance components 411 through 414 during startup, i.e., when the AT 82 is initially establishing a communications link with the BSP 92 via the antenna apparatus 400. During start-up (beginning in Step 903), the antenna apparatus 400 is placed in omni-mode (Step 906). The antenna apparatus 400 locks onto the “best” BSP 92 (Steps 909-921) and performs an initial pilot scan (Step 924).

The field unit 210 may include a sophisticated digital receiver that can provide output parameters such as Eₛ/Nₒ, Pilot Power, Total Received Power, RMS Delay Spread (if a so-called “rake receiver” is used to separate multipath), Forward Error Rate (FER), and other receiver signal metrics. Other technology capable of determining these signal metrics may alternatively be employed.

The antenna apparatus 400 is then put in directive mode, and the same parameters are recorded at each of the 1 through i'th different pointing angles or modes (Step 927). It should again be understood that the principles of the present invention are based in part on the observation that the location of the BSP 92 in relation to any one field unit 210 (e.g., laptop 80) is approximately circumferential in nature. That is, if a circle is drawn around a field unit and different locations are assumed to have a minimum of one degree of granularity between any two locations, the BSP 92 can be located at any of a number of different pointing angles or modes. Assuming accuracy to ten degrees, for example, there are thirty-six different possible modes or setting combinations that exist for such an antenna apparatus 400. Each phase setting combination can be thought of as a set of five impedance values, one for each selectable impedance component 410-414 electrically connected to respective passive antenna elements 401 through 405.

Once this “database” is generated, each mode, including the omni-mode, is ranked from 1 through i'th plus omni-mode using a ranking process (Step 933). The preferred angle or mode ranking process of choice may include using Eₛ/Nₒ and Pilot Power, as shown below:

Rank (A₀)=Es₀/No₀+PilotPwr₀

Rank (A₁)=Es₁/No₁+PilotPwr₁

Rank (A₂)=Es₂/No₂+PilotPwr₂

where:

Eₛ/Nₒ=energy per pilot symbol to total noise ratio in decibels (dB's);

PilotPwr=Received Pilot Power of Selected Base Station in decibels referenced to 1 milliwatt (dBm's); and

Rank(Aᵢ)=the ranking value for the i'th mode or angle.

This metric is preferred because correlated power has a much stronger relationship to reverse link performance than signal-to-noise. For example:

Angle 6: Eₛ/Nₒ=8dB PilotPwr=−100dBm Ranking Value=−92

Angle 10: Eₛl /Nₒ=6.5 dB PilotPwr=−92 dBm Ranking Value=−85.5

In general, if only Eₛ/Nₒ is used, then Angle 6 is ranked higher than Angle 10 even though there is only a 1.5 dB difference in Eₛ/Nₒ. By using PilotPwr in the ranking, Angle 10 is ranked higher, which, in many cases, results in a more acceptable reverse link.

Although it may be suggested that, since power control is available, it does not matter if transmit power of the subscriber must be increased. This is true (i) if there is an infinite amount of transmit power in the subscriber unit, and (ii) if the additional power being transmitting does not contribute to same cell and other cell interference. Since this is not the case, it is better to try to balance the forward and reverse links as best as possible.

Because pilot symbols are used for the Eₛ/Nₒ measurement metric in the angle ranking, antenna pointing decisions can be made before traffic channels are ever set-up. Additionally, since the pilot power is traditionally fixed, this gives a stable baseline that linearly degrades as interference and multi-path get worse.

The Eₛ/Nₒ of the Pilot Signal is used as opposed to the Eₛ/Nₒ of Traffic signals, since there are times when no Traffic data is being sent. Referring to the noise component of this metric, Eₛ/Nₒ, if the forward link is assumed to be interference limited, the biggest contributor to No is interference from adjacent cells and multi-path. By using Pilot Eₛ/Nₒ, which starts with a fixed ratio, any degradation in this ratio is expected to come from adjacent cell interference and multi-path.

Other factors that could be used in ranking the modes include Total Received Power, RMS Delay Spread, and FER, as mentioned above.

Returning attention to FIG. 9A, the processor 350 then provides and sets the optimal impedance for each selectable impedance component 411 through 414 using the highest ranking antenna mode first (Step 936). Next, a reverse link connection is initiated using the highest ranked antenna mode (Step 939). If a suitable connection cannot be made (Step 942), the processor 350 sets the next highest ranked candidate mode (Steps 945-948), and a reverse link connection is initiated using this mode. This process continues until a successful reverse link connection is achieved, the number of candidate modes to try is reached, or the omni mode is reached (Steps 942-954).

This process 900 can be used to point a directional antenna operating in virtually any environment but is particularly suited for use in cellular networks, Wireless Local Area Networks (WLANs), or other environments that are strongly influenced by interference/multi-path or operate using a different transmit (TX) and receive (RX) frequency.

An alternative selection process may be used to choose the “best”—base station as opposed to the best angle for an already-selected base station—to set the direction of the antenna apparatus 400 based on a ranking process. An example of this alternative process is shown in FIG. 9B. Similar to choosing a best angle setting following selection of the base station in omni mode as described in reference to FIG. 9A, setting the direction of the antenna apparatus 400 is accomplished by setting the impedance for each selectable impedance component 411 through 414.

Referring to FIG. 9B, during start-up (beginning in Step 905), the antenna apparatus 400 is placed in directional-mode (Step 957), and the antenna apparatus 400 locks onto 1 of i'th BSPs 92 and performs an initial pilot scan (Step 909).

The antenna apparatus 400 then records the same parameters at each of the 1 through i'th different pointing BSPs (Steps 924-930).

Once this database is generated (Step 960), each BSP is ranked from 1 through i'th using a ranking process (Step 963). The preferred “best” BSP ranking process of choice is using Eₛ/Nₒ and Pilot Power, as shown below:

Rank (A₀)=EsₒNo₀+PilotPwr₀

Rank (A₁)=Es₁/No₁+PilotPwr₁

Rank (Aᵢ)=Esᵢ/Noᵢ+PilotPwrᵢ

where:

Eₛ/Nₒ =energy per pilot symbol to total noise ratio in decibels (dB's);

PilotPwr=Received Pilot Power of Selected Base Station in decibels referenced to 1 milliwatt (dBm's); and

Rank(Aᵢ)=the ranking value for the i'th BSP.

Continuing to refer to FIG. 9B, the processor 350 then provides and sets the optimal impedance for each selectable impedance component 411 through 414 using the highest ranking BSP first (Step 966). Next, a reverse link connection is initiated using the highest ranked BSP (Steps 969-972 and 939). If a suitable connection cannot be made (Step 942), the processor 350 sets the antenna angle toward the next highest ranked candidate BSP (Steps 975-978), and a reverse link connection is initiated using this mode. This process continues until a successful reverse link connection is achieved or the number of candidate BSPs to try is reached (Steps 951-954).

This process can be used to point a directional antenna 400 operating in virtually any environment but is particularly suited for use in cellular networks or other environments that are strongly influenced by interference/multi-path and that operate using different transmit (TX) and receive (RX) frequencies.

The selection process described above may be improved or fine tuned by adding predetermined or adaptively learned information about the operating environment or directivity of the directive antenna 400. This information is represented in the field unit 210, or other system in which the present invention is employed, as weights.

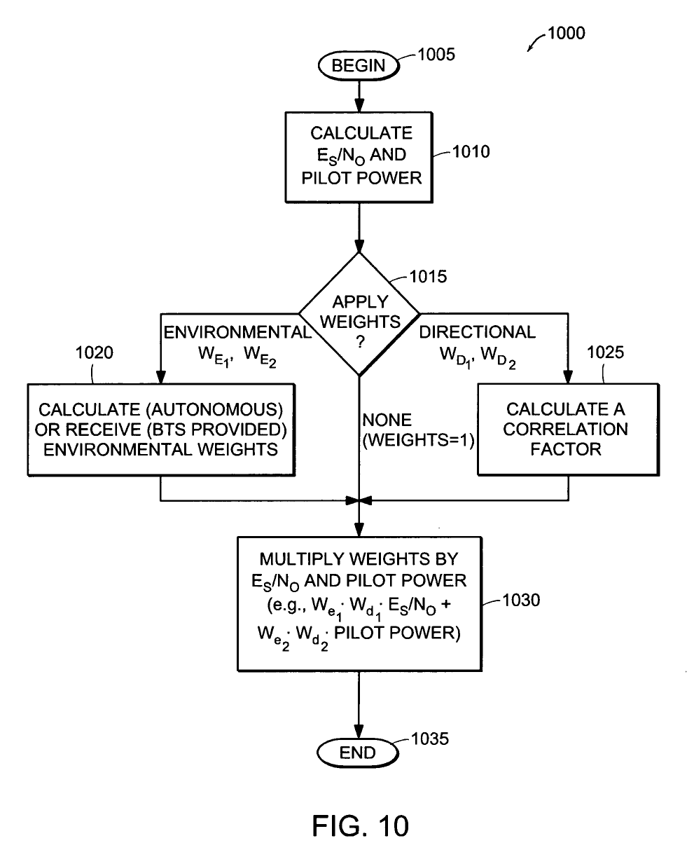

FIG. 10 is a flow diagram of a process 1000 in which these weights are applied to the metrics related to noise and predetermined signal power learned through use of the scanning process 800.

Referring to the process 1000, the process 1000 begins (step 1005) and calculates the noise-related metric (e.g., Eₛ/Nₒ) and pilot power metric using, for example, steps 805 and 810 discussed above in reference to FIG. 8 (step 1010). If weights are to be applied (step 1015), then the selected weights are determined in steps 1020 and 1025.

If the weights are environmental in nature, the process 1000 calculates or receives the environmental weights (step 1020). If calculating the weights, the field unit 210 is operating in an autonomous mode (i.e., the field unit self-determines the environmental weights). If the field unit receives the environmental weights, the base station has provided these weights via wireless communication, and, thus, the field unit 210 has not acted autonomously.

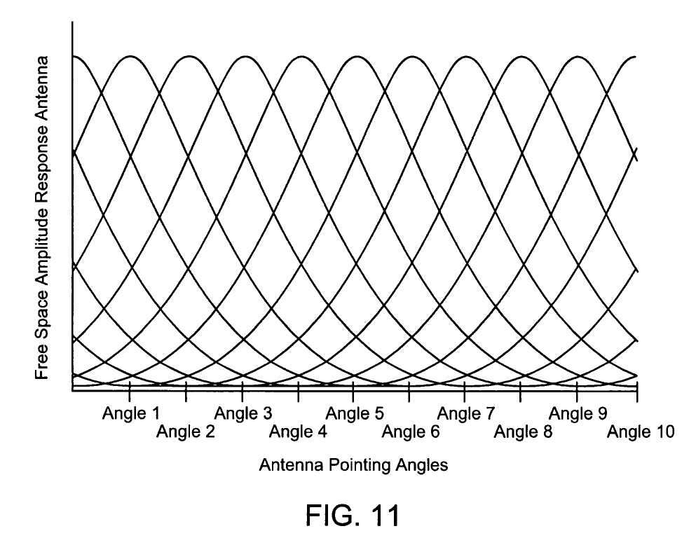

If the weights to be applied are based on the directivity of the directional antenna (i.e., the weights are directional), the process 1000 may calculate, receive, or be preprogrammed with a Correlation Factor (CF) (step 1025). The correlation factor is a particular type of weighting and based on the antenna pattern. The correlation factor is discussed further below in reference to FIGS. 11-13.

If no weights are to applied, the weightings are set to the value “1”. The process 1000 multiplies the weights by the respective metrics. For example, a first environmental weight and first directional weight may be multiplied by the metric that is a function of noise, and a second environmental weight and second directional weight may be multiplied by the metric related to pilot power (step 1030). When the process 1000 ends (step 1035), the weighted metrics may be stored in a table, database, or sent to the real-time running program on the field unit 210 for use in making an angle selection. The weighted metrics can then be used similar to the non-weighted metrics, as discussed above.

One way to establish the weights relative to the environment (i.e., environmental adjustment factors) for different areas is based on simulations of different statistically significant environments, such as urban, suburban, or rural. Other ways to establish these weights can be based on actual field measurements. Alternatively, these weights can be established in real-time based on an optimization routine using a kernel based on simulations or blind adaptive optimization.

An optimization routine can be set-up to optimize different metrics based on the needs of the specific network. For example, in dense urban areas, forward capacity, i.e., forward signal-to-noise ratio (SNR), may be considered a greater concern than range improvements, so the process can be set to converge on best SNR for each user. Likewise, in rural areas, coverage can be considered a greater concern, so received signal power or subscriber transmit power may be optimized.

One way to implement the adjustment factors is to preprogram values into each field unit 10. These values may be based on geographic areas, i.e., planet earth, different continents, different countries, different regions within the different countries, and the user's home area network. These values allow for macro adjustments of the process based on the geographic area in which a user operates their field units. These values do not account for relocation of the user to a different geographic area or a major variation within the user's own geographic area. Therefore, there is a high probability the weights related to environment may not be correct for the user's field units if the user moves to a new geographic area or a major variation within the user's own geographic area.

A second way to implement the adjustment factors is to embed a predefined database in the field unit 210. The predefined database may include different weights for a set of predefined environments, e.g., rural, suburban, urban, and metropolitan areas. When a user logs onto a particular network, the base station may notify the field unit of the type of environment in which the user is located. The field unit loads the predefined value associated with the environment from its internal database based on the information provided by the base station. This method does not easily allow for changes to the weighting factors for different environments, nor does it support real-time adjustments of the factors.

The preferred method uses specific weights for the smallest definable region. These weights may be dynamically downloaded to the user's field unit during login, or the weights can be continuously broadcast to the user's field unit. In a cellular network, each base station may contain its own set of weights that may be downloaded to each user over some control channel or broadcast over a broadcast channel. The network engineer who is managing a particular site can “tweak” these parameters to further optimize performance in a particular cell. The parameters the network engineer can “tweak” may be based on capacity, time of day, or a Link Quality Metric (LQM). Automatic tweaking of the weights may be accomplished using a network optimization tool, which monitors the overall system and network performance. The optimization tool collects link statistics and builds a database of the performance of users within the cell. The optimization tool inputs the statistics into a real-time modeling program and uses permutation techniques, for example, to try and solve for the optimum weights that maximize overall system performance.

The preferred angle or mode ranking algorithm of choice is using Eₛ/Nₒ and Pilot Power, as shown below:

Rank (A₀)=RfAntEsNoWgt×Es₀/No₀+RfAntPilotWgt×PilotPwr₀

Rank (A₁)=RfAntEsNoWgt×Es₁/No₁+RfAntPilotWgt×PilotPwr₁

Rank (Aᵢ)=RfAntEsNoWgt×Esᵢ/Noᵢ+RfAntPilotWgt×PilotPwrᵢ

where:

Eₛ/Nₒ=energy per pilot symbol to total noise ratio in decibels (dB's);

PilotPwr=Received Pilot Power of Selected Base Station in decibels referenced to 1 milliwatt (dBm's);

Rant(Aᵢ)=the ranking value for the i'th mode or angle;

RfAntEsNoWgt=the Eₛ/Nₒ weight that is downloaded from the current Base Station, internal, or adaptively determined that defines how the Eₛ/Nₒ should factor into the pointing decision for that base station environment; and

RfAntPilotWgt=the Pilot Power weight that is downloaded from the current Base Station, internal, or adaptively determined that defines how the Pilot Power should factor into the pointing decision for that base station environment.

The Eₛ/Nₒ of the Pilot Signal is used as opposed the Eₛ/Nₒ of Traffic signals for the same reason as discussed above, namely, the pointing direction decision preferably occurs during initial system access when no Traffic data is being sent. If the forward link is assumed to be interference limited, the biggest contributor to No is interference from adjacent cells and multi-path. By using Pilot Eₛ/Nₒ, one starts with a fixed ratio, and any degradation in this ratio comes from adjacent cell interference and multi-path.

Other factors that can be used in ranking the modes include Total Received Power, RMS Delay Spread, and FER, as mentioned above.

In addition to weights related to the operating environment that can be applied to the metrics to fine tune the pointing, weights related to the antenna directivity or beam pattern can also be applied to the metrics for fine tuning. These directional weights can be applied independent of or in addition to the environmental weights.

An example of a directional weight is an Antenna Pattern Correlation Factor (CF). The CF is a comparison between a free space antenna pattern of a directional antenna and any metric recorded as a function of the antenna pointing direction. The patterns can be, but are not limited to, expressions in continuous form or discrete measurements. The comparison can be performed by continuous or discrete convolution or by some other comparison technique, such as least-mean-square.

One type of comparison compares the free space pattern of the directional antenna 400 to pilot power. The comparison locates the center of mass of the pilot energy and forms a metric to describe the presence and severity of the multipath environment.

FIG. 11 illustrates a theoretical free space directional antenna pattern replicated ten times using ten different reference positions, Angle 1 through Angle 10. The free space reference pattern may be obtained by measuring the antenna in a nonreflecting environment. To quantify the multi-path environment, it is useful to use the free space antenna pattern because a determination must be made on how much the measured pattern (e.g., the pilot power) deviates from the free space pattern. The lower the value of the comparison (i.e., a smaller CF) between the measured pattern and the free space directional antenna pattern, the more severe the multi-path environment. Likewise, the higher the value of the comparison, the less severe the multi-path environment.

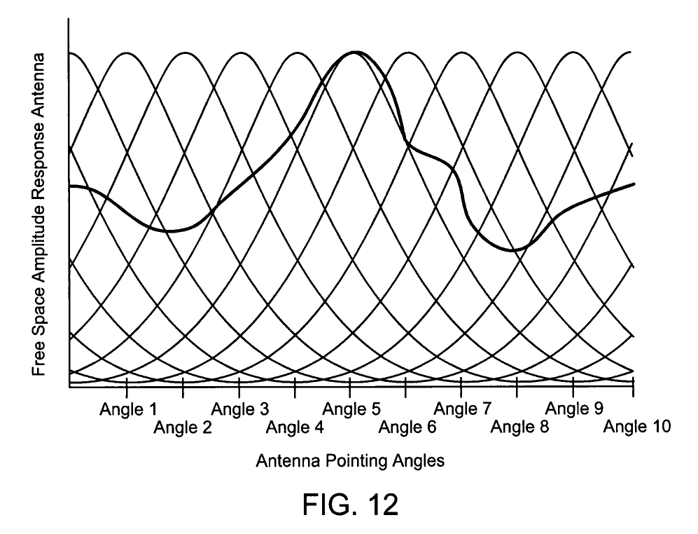

FIG. 12 illustrates a theoretical free space directional antenna and a theoretically measured pilot power pattern. As shown in FIG. 12, Angle 5 has the highest correlation between each of the ten free space antenna patterns and the measured pilot power pattern. Therefore, Angle 5 is selected as the optimum pointing angle. However, calculating the maximum CF further optimizes the pointing angle. The maximum CF can be calculated using the correlation value computed using Angle 5 and a complex pointing process. The CF is smaller in environments with greater multi-path angular spread and larger in environments with less multi-path angular spread. One method to calculate CF for each antenna position j is to use the following equation:

CFⱼ=1−(sum_{i-32 1->A}(sqrt(abs(Diff_{i,j})/X)

where:

CF is the correlation factor;

“A” is the total number of angles measured;

“Diff” is the difference between the i'th measured value and the j'th antenna pattern; and

“X” is the maximum total difference that is obtained if a flat noise pattern is convolved with the actual free space antenna pattern.

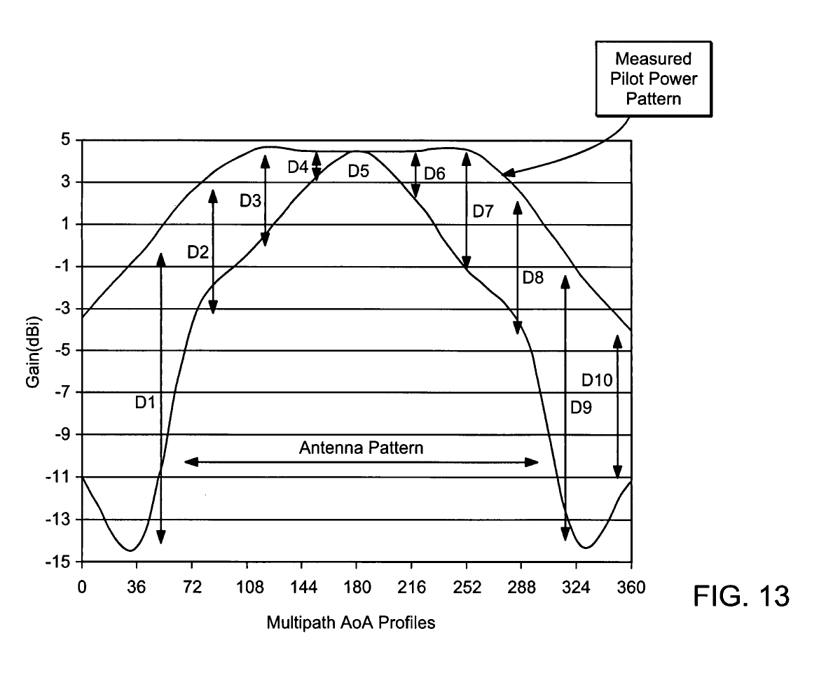

FIG. 13 illustrates a process to compute the maximum CF using an actual measured free space antenna pattern and a measured pilot power pattern. The process may be described, in list format, as follows:

Outer Loop

1. Normalize the peak of the measured pilot pattern to the peak of the free space antenna reference patterns;

2. Select the first of the ten different free space antenna patterns;

Inner Loop

a. Convert the measured pilot power pattern and the recorded free space reference patterns to power in watts.

b. Calculate the difference between the free space reference pattern and the measured pilot pattern at the current angle (Diff).

c. Calculate the absolute value of the difference;

d. Calculate the square root of the difference;

e. Divide that difference by the maximum total difference of what is obtained if a flat noise pattern is convolved with the actual free space antenna pattern. For example, for the directional antenna 400, the value is 7.6951;

f. Perform the Inner Loop b through e until D1 through D10 have been computed;

g. Sum the results of D1 through D10 and subtract this value from 1;

3. Select the next free space antenna pattern and perform the Inner Loop again;

4. Once all 10 free space reference patterns have a CF computed, the reference pattern with the largest value (between 0 and 1) is the direction of the center of mass of the pilot energy with a value of CF that is CFmax.

Once the database of modes (i.e., angles or base stations as discussed in referenced to FIG. 7) and CFₘₐₓ is generated, each mode is ranked from 1 through i'th using a weighted ranking process to obtain the optimum pointing angle. One example of a weighted ranking process is to weight the PilotPwr by the CF. Simulations and measurements have shown it is desirable to weight the received PilotPwr less as the multi-path environment gets worse because the PilotPwr in the Ranking equations is used to match the Forward and Reverse Links. It is difficult to find a predominant angle of arrival of the Base Station pilot as the multi-path environment gets worse. Hence, the contribution to the ranking by the PilotPwr is preferably reduced. The preferred angle or mode ranking process of choice is using Eₛ/Nₒ and weighted Pilot Power, as shown below:

Rank (A₀)=Es₀/No₀+CFₘₐₓ×PilotPwr₀

Rank (A₁)=Es₁/No₁+CFₘₐₓ×PilotPwr₁

Rank (Aᵢ)=Esᵢ/Noᵢ+CFₘₐₓPilotPwrᵢ

Where:

Eₛ/Nₒ=energy per pilot symbol to total noise ratio in decibels (dB's);

PilotPwr=Received Pilot Power of Selected Base Station in decibels referenced to 1 milliwatt (dBm's);

Rank(Aᵢ)=the ranking value for the i'th mode or angle; and

Cfₘₐₓ=largest correlation factor.

In addition to applying the CF to the ranking process alone, the CF can be applied in combination with the environmental weights, as follows:

Rank(A₀)=RfAntEsNoWgt×Es₀/No₀+CFₘₐₓRfAntPilotWgt×PilotPwr₀

Rank(A₁)=RfAntEsNoWgt×Es₁/No₁+CFₘₐₓ×RfAntPilotWgt×PilotPwr₁

Rank(Aᵢ)=RfAntEsNoWgt×Esᵢ/Noᵢ+CFₘₐₓ×RfAntPilotWgt×PilotPwrᵢ

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for determining an angle setting for a directional antenna, comprising:
for at least two angle settings associated with the directional antenna:
calculating received power of a predetermined transmitted signal;
calculating a metric as a function of noise in a channel associated with the predetermined transmitted signal; and
selecting an angle setting for the directional antenna based on a combination of the received power and the metric.

2. The method according to claim 1 wherein the predetermined transmitted signal is a pilot signal or a beacon signal.

3. The method according to claim 1 further including applying at least one weight to the received power, metric, or both.

4. The method according to claim 3 wherein said at least one weight is related to the operating environment or directivity of the directional antenna.

5. The method according to claim 4 further including calculating the weight related to the operating environment.

6. The method according to claim 4 further including receiving the weight related to the operating environment.

7. The method according to claim 4 wherein the weight related to the directivity of the directional antenna includes a correlation factor.

8. The method according to claim 1 further including searching for the predetermined transmitted signal.

9. The method according to claim 8 wherein calculating the received power and metric occurs during the searching.

10. The method according to claim 1 wherein the metric is defined as energy per symbol divided by the total noise of the channel.

11. The method according to claim 1 further including attempting to establish a reverse link at a scan angle corresponding to a maximum of the combinations generated for each angle setting.

12. The method according to claim 11 wherein, if unable to establish the reverse link, re-attempting at a scan angle corresponding to a lower value of the combinations.

13. The method according to claim 1 used in a Code Division Multiple Access (CDMA) network, Frequency Division Multiple Access (FDMA) Network, Time Division Multiple Access (TDMA) Network, or Wireless Local Area Network (WLAN).

14. An apparatus for wireless communications, comprising:
a directional antenna to receive a predetermined transmitted signal;
a processor coupled to the directional antenna to calculate, for at least two angle settings associated with the directional antenna, (i) received power of the predetermined signal and (ii) a metric as a function of noise in a channel associated with the predetermined transmitted signal; and
a selector coupled to the processor to select an angle setting for the
directional antenna based on a combination of the received power and the metric.

15. The apparatus according to claim 14 wherein the predetermined transmitted signal is a pilot signal or a beacon signal.

16. The apparatus according to claim 14 wherein the processor applies at least one weight to the received power, metric, or both.

17. The apparatus according to claim 16 wherein said at least one weight is related to the operating environment or directivity of the directional antenna.

18. The apparatus according to claim 17 wherein the processor calculates the weight related to the operating environment.

19. The apparatus according to claim 17 wherein the processor receives the weight related to the operating environment.

20. The apparatus according to claim 17 wherein the weight related to the directivity of the directional antenna includes a correlation factor.

21. The apparatus according to claim 14 wherein the processor controls the directional antenna to search for the predetermined transmitted signal.

22. The apparatus according to claim 21 wherein the processor calculates the received power and metric during the searching.

23. The apparatus according to claim 14 wherein the metric is defined as energy per symbol divided by the total noise of the channel.

24. The apparatus according to claim 14 wherein the processor attempts to establish a reverse link at a scan angle corresponding to a maximum of the combinations generated for each angle setting.

25. The apparatus according to claim 24 wherein, if the processor is unable to establish a reverse link, it re-attempts at a scan angle corresponding to a lower value of the combinations.

26. The apparatus according to claim 14 used in a Code Division Multiple Access (CDMA) Network, Frequency Division Multiple Access (FDMA) Network, Time Division Multiple Access (TDMA) Network, or Wireless Local Area Network (WLAN).

27. An apparatus for determining an angle setting for a directional antenna, comprising:
for at least two angle settings associated with the directional antenna:
means for calculating received power of a predetermined transmitted signal;
means for calculating a metric as a function of noise in a channel associated with the predetermined transmitted signal; and
means for selecting an angle setting for the directional antenna based on a combination of the received power and the metric.
